(19) United States
(12) Patent Application Publication
(10) Pub. No.: US 2008/0125044 A1
(43) Pub. Date: May 29, 2008

(54) Audio output system and method for mobile phone

(75) Inventor: Ju Yun Kim, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/825,599

(22) Filed: Jul. 5, 2007

(30) Foreign Application Priority Data
Nov. 28, 2006 (KR) 2006-0118202

(51) Int. Cl. H04B 7/00; G10L 21/00; H04M 1/00; H04R 25/00

(52) U.S. Cl. 455/41.2; 381/374; 455/550.1; 455/575.2; 704/201

(57) ABSTRACT

An audio output system and method for a mobile phone that enables a sound effect to be applied to an audio signal at a headset are provided. The audio output method for a portable device outputting a sound through a sound output device includes establishing a communication channel between the portable device and the sound output device; transmitting an audio stream from the portable device to the sound output device; applying, at the sound output device, a sound effect to the audio stream; and outputting the sound effect-applied audio stream.

### CLAIM OF PRIORITY

This application claims priority to an application entitled “AUDIO OUTPUT SYSTEM AND METHOD FOR MOBILE PHONE,” filed in the Korean Intellectual Property Office on Nov. 28, 2006 and assigned Serial No. 2006-0118202, the entire contents of which are incorporated herein by reference.

### BACKGROUND OF THE INVENTION

1. Field of the Invention

The present invention relates to a mobile phone and, in particular, to an audio output system and method for a mobile phone that enables a sound effect to be applied to an audio signal at a headset.

2. Description of the Related Art

Mobile phones are one of the most widely used electronic devices, and most recent mobile phones incorporate various supplementary function modules such as a Motion Picture Experts Group-1 Audio Layer 3 (MP3) player, a Digital Multimedia Broadcast (DMB) receiver, a motion picture player, and a camera.

Typically, such supplementary modules produce audio sounds such as movie sound and music. In order to listen to the sounds in a public place without invasion of other's privacy, a headset or an earphone is used.

The conventional headsets and earphones are passive devices for only outputting the audio signals received from the mobile phone as audible sound waves. Recently, wireless headsets have emerged. A wireless headset is equipped with a short range wireless communication module for receiving audio signals from the mobile phone through a radio channel. Some wireless headsets are provided with a remote control function enabling control of the supplementary functions of the mobile phone.

However, the conventional headset, especially the wireless headset, having a remote control function supports only playback control of some supplementary function but not sound effect control. Accordingly, when the mobile phone is carried in a pocket or a backpack, a user must take the mobile phone out of the pocket or backpack in order to activate or change a sound effect set for improving an output sound, resulting in user inconvenience.

### SUMMARY OF THE INVENTION

The present invention provides an audio output system and method for applying at a headset a sound effect to an audio signal received from a mobile phone.

In accordance with an embodiment of present invention an audio output method for a portable device is provided for outputting a sound through a sound output device. The audio output method includes establishing a communication channel between the portable device and the sound output device; transmitting an audio stream from the portable device to the sound output device over the established communication channel; at the sound output device, performing the steps of:

applying a sound effect to the transmitted audio stream by, and

outputting the sound effect-applied audio stream.

In accordance with another embodiment of the present invention, the modification of the audio output stream with a sound effect is accomplished by an audio output system. The audio output system includes an audio playback device for outputting an audio stream modified by a sound effect; and a sound output device connected to the audio playback device for receiving the modified audio stream and outputting the modified audio stream as an audible sound.

### BRIEF DESCRIPTION OF THE DRAWINGS

The above and other features and advantages of the present invention will be more apparent from the following detailed description in conjunction with the accompanying drawings, in which:

FIG. 1 is a schematic diagram illustrating an audio output system and method for a mobile phone, according to a first embodiment of the present invention;

FIG. 2 is a block diagram illustrating a configuration of a mobile phone of an audio output system, according to a first embodiment of the present invention;

FIG. 3 is a block diagram illustrating a configuration of a headset of the audio output system, according to a second embodiment of the present invention;

FIG. 4 is a block diagram illustrating a configuration of a second audio processing unit of the headset in FIG. 3; and

FIG. 5 is a flowchart illustrating an audio output system, according to the present invention.

### DETAILED DESCRIPTION OF EMBODIMENTS

Embodiments of the present invention are described in detail in the following sections with reference to the accompanying drawings. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

Certain terms are used in the following description for convenience and reference only and are not intended as limiting. In the following detailed description, only the embodiments of the invention have been shown and described as illustrative examples of the best mode contemplated by the inventors of carrying out the invention. As will be realized, the invention is capable of modification in various obvious respects, all without departing from the true scope and spirit of the invention as claimed herein. Accordingly, the drawings and description are to be regarded as being only illustrative in nature and not restrictive in any sense.

In a first embodiment, an audio output system and method for a mobile phone are described using a Bluetooth-enabled headset. However, the present invention is not limited thereto. For example, the audio output system and method of the present invention can be implemented with other short range wireless communication technologies including Zigbee, Ultra Wideband (UWB), and Infrared Data Association (IrDA).

Also, the audio output system and method of the present invention is not limited to a headset. For example, the headset can be replaced with a wireless ear-set, wireless speaker, and equivalents thereof having an audio output function.

In the first embodiment, the audio output system and method are described as including a mobile phone. The mobile phone can include a Personal Digital Assistant (PDA), a Smartphone, a laptop computer, a Smartphone, a 3^{rd} generation standard mobile terminal, a Code Division Multiple Access (CDMA) terminal, a Global System for mobile communication (GSM) terminal, a Global Packet Radio Services (GPRS) terminal, a Wireless Local Area Network (WLAN) terminal, a Wireless Broadband (WiBro) Terminal, or a High Speed Downlink Packet Access (HSDPA) terminal.

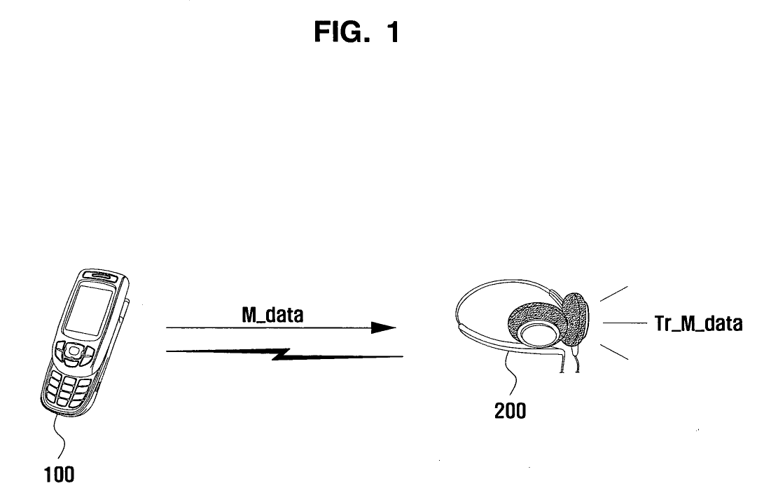

FIG. 1 is a schematic diagram illustrating an audio output system and method for a mobile phone according to the first embodiment of the present invention.

Referring to FIG. 1, the audio output system includes a mobile phone 100 as an audio player and a headset 200 as a sound output device 200 for receiving an audio signal (M_data) from the mobile phone 100 and converting the audio signal into an audible sound wave.

The M_data generated at the mobile phone 100 is transmitted to the headset 200 and is reinforced and modified at the headset 200 according to a user configuration so as to be reproduced as a modified audio signal (Tr_M_data). The Tr_M_data is then converted into an audible sound wave to be output through speakers.

When the mobile phone 100 operates in an MP3 playback mode or a radio receiver mode, the M_data output by the mobile phone 100 is transmitted to the headset 200. The M_data is processed at the headset 200 according to a sound modification setting configured by a user and then is output as a Tr_M_data. The Tr_M_data is converted into an audible sound wave so as to be output through speakers. M_data can include music, a recorded voice, and nature sounds.

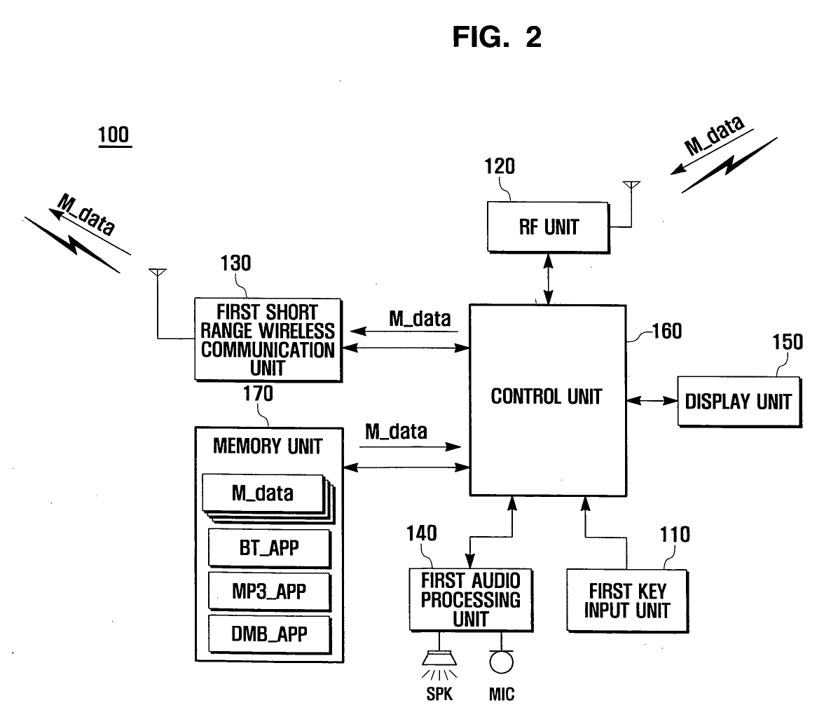

FIG. 2 is a block diagram illustrating a configuration of a mobile phone of the audio output system according to the first embodiment of the present invention.

Referring to FIG. 2, the mobile phone 100 includes a first short range wireless communication unit 130, a memory unit 170, a first key input unit 110, a display unit 150, a first audio processing unit 140, a radio frequency (RF) unit 120, and a control unit 160.

The first short range wireless communication unit 130 can include Bluetooth, Zigbee, UWB, or IrDA technology. In the first embodiment, the first short range wireless communication unit 130 is implemented using a Bluetooth module. Bluetooth is an industrial specification for wireless personal area networks.

Bluetooth operates in the unlicensed Industrial Scientific Medical (ISM) band at 2.4 Gigahertz using 79 channels between 2.402 GHz to 2.480 GHz (23 channels in some countries). The range for Bluetooth communication is up to 10 meters with a power consumption of 0 dBm (1 mW). This distance can be increased to 100 meters by amplifying the power to 20 dBm. The Bluetooth radio system is optimized for mobility. Bluetooth operates with very low power, as little as 0.3 mA in standby mode and 30 mA during sustained data transmissions. Bluetooth uses a fast frequency hopping spread spectrum (FHSS) technique for avoiding interference. With 78, 1 MHz channels, Bluetooth provides a lower guard band of 2 MHz and an upper guard band of 3.5 MHz. Bluetooth is classified into three classes by transmit power: class 1 up to 100 mW, class 2 up to 2.4 mW, and class 3 up to 1 mW. Also Bluetooth uses Gaussian Frequency Shift Keying (GFSK) and supports 3 SCO channels with A-Law, u-Law PCM, and Continuous Variable Slope Delta Modulation (CVSD).

The memory unit 170 stores application programs for executing various supplementary functions of the mobile phone 100. The application programs particularly include a Bluetooth application (BT_App), an MP3 application (MP3_App), and a DMB application (DMB_App). The memory unit 170 can be divided into a program region and a data region.

The program region stores an operating system (OS) for booting the mobile phone 100 and application programs for playing various multimedia contents and controlling various supplementary functions such as a camera and Bluetooth, MP3, and DMB functions. When a supplementary function is activated by a user request, the mobile phone 100 executes the application programs associated with the supplementary function under the control of the control unit 160.

The data region stores audio and video data such as MP3 files and motion picture files. The audio data are transmitted to the headset 200 as the M_Data under the control of the controller 160.

The first key input unit 110 is provided with a plurality of alphanumeric keys for receiving a user key input and a plurality of function keys for executing corresponding functions. The function keys include navigation keys, side keys, and shortcut keys. The first key input unit 110 transports a signal generated by a key input to the control unit 160.

Particularly, the first key input unit 110 is implemented so as to input a signal for configuring an audio output path for the headset 200. In detail, if a user key input is detected for playing a multimedia file item listed on a playlist screen provided by the display unit 150, the first key input unit 110 generates a key signal corresponding to the user key input and transmits the key signal to the control unit 160.

The display unit 150 displays various menu screens associated with the application programs, information input by a user, and execution screens of the application programs.

Particularly, the display unit 150 also presents a menu screen for the user to select the headset 200 as an audio output device and provides information on a connection status between the mobile phone 100 and the headset 200. The display unit 150 also provides function screens associated with an MP3 playback function after the mobile phone 100 is connected to the headset 200.

The first audio processing unit 140 processes the M_Data including a voice and other audio signals and plays back the MP3 file and DMB stream to be output as equivalent M_data.

Particularly, the first audio processing unit 140 transports the M_data to an internal speaker (SPK) when the headset 200 is not connected to the mobile phone 100. In an external device output mode, i.e. when the headset 200 is connected to the mobile phone 100, the first audio processing unit 140 transmits to M_data to the headset 200 while an audio output path to the speaker (SPK) is blocked.

The RF unit 120 is responsible for a radio communication with a base station. The RF unit 120 includes an RF transmitter for up-converting and amplifying a transmission signal and an RF receiver for low-noise amplifying and down-converting a received signal.

Particularly, the RF unit 120 establishes a radio communication channel with a system for a voice communication with a counter part user. If the mobile phone 100 operates in an external device output mode, i.e. when the headset 200 is connected to the mobile phone 100, the voice signal received from the counter part user can be transmitted to the headset 200. The RF unit 120 can receive the audio signal (M_data) from outside and transmit the M_data to the control unit 160.

The control unit 160 controls general operations of the mobile phone 100 and cooperative operation between the internal operation units. The control unit 160 can include a modem and a codec. The control unit 160 further includes a sub-band codec (SBC) for a Bluetooth communication, i.e. a sub-band encoder. The sub-band encoder converts data output by the codec, for example, a Pulse Cod Modulation (PCM) data can be converted into a Bluetooth data.

Particularly, the control unit 160 controls the first short range wireless communication unit 130 to establish a communication channel to the headset 200. When an incoming call is received while the mobile phone 100 operates in the MP3 playback mode, the control unit 160 performs a call connection procedure and the voice signal sent from the counter part terminal to the headset 200 as M_data after the call connection is received successfully. The control unit 160 transmits a predetermined incoming call alert signal to the headset 200 when the incoming call is received and establishes a communication channel to the headset 200 if an incoming call response signal is received from the headset 200.

Although the mobile phone 100 is schematically depicted as illustrated in FIG. 2, the present invention is not limited to the configuration of FIG. 2. For example, the mobile phone can further include at least one of camera and a multimedia processing unit.

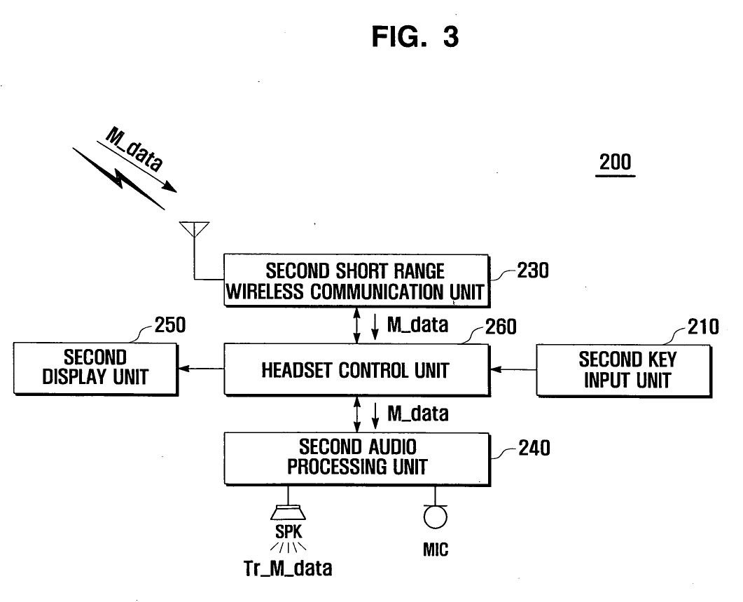

FIG. 3 is a block diagram illustrating a configuration of a headset of the audio output system according to the first embodiment of the present invention.

Referring to FIG. 3, the headset 200 according to a second embodiment of the present invention includes a second short range wireless communication unit 230, a second audio processing unit 240, a second key input unit 210, a headset control unit 260, and a second display unit 250.

The second short range wireless communication unit 230 is implemented with a Bluetooth module identical to that of the first short range wireless communication unit 130. The second short range wireless communication module 230 can establish an ad hoc network, i.e. a piconet, with other Bluetooth devices including the mobile phone 100, such that the headset can receive M_data through a Bluetooth channel established between the first and second short range wireless communication units 130 and 230.

The second audio processing unit 240 processes the M_data received from the mobile phone 100 and outputs the M_data through a speaker (SPK), and receives a voice sound input through a microphone (MIC). The second audio processing unit 240 can reinforce and enrich the M_data before outputting the reinforced and enriched M_data through the speaker (SPK) as Tr_M_data).

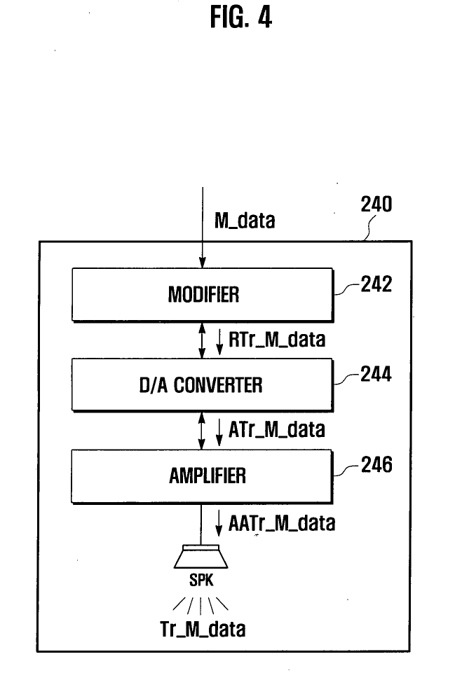

FIG. 4 is a block diagram illustrating a configuration of a second audio processing unit of the headset in FIG. 3.

In FIG. 4, the second audio processing unit 240 includes a modifier 242, a digital/analog (D/A) converter 244, and an amplifier 246.

The modifier 242 reinforces and enriches the M_data received through the second short range wireless communication unit 230 and decoded at the headset control unit 260, and outputs the reinforced and enriched M_data as a modified audio signal (Raw Transduced M_data (RTr_M_data)) to the D/A converter 244. In order to perform the modification on the M_data, the modifier 242 is implemented with a digital signal process (DSP) chip having a function for applying sound effects, including three-dimensional, pop, classic, rock, jazz, and dance effects. The modifier 242 can boost or attenuate the frequency bands of the M_data. For example, in order to apply the 3D effect, the modifier 242 delays some frequency components of the M_data. The modifier 242 enables configuration of detailed equalizer modes for adjustment of the frequency bands. That is, the modifier 242 provides a plurality of equalizer bands for adjusting frequency band including a bass frequency and soprano frequency. The equalization of the frequency bands is manipulated through the second key input unit 210 such that the M_data is modified in respective frequency bands to be output as Raw Transduced M_data (RTr_M_data).

The second key input unit 210 can be arranged at a side of the headset 200 in the form of a set of buttons and a jog disc and generates control signals that include receiving and blocking the M_data, modifying the received M_data, and adjusting a volume of the M_data. The second key input unit 210 can be implemented with one of multiple buttons for corresponding functions and a signal button that can be used to control the multiple functions.

The headset control unit 260 controls: signaling between the second short range wireless communication unit 230, the second audio processing unit 240, and the second key input unit 210; decoding the M_data received from the mobile phone 100; and transmitting control signals related to the call connection and key input to the mobile phone 100. The headset control unit 260 incorporates a sub-band codec, particularly a sub-band decoder, identical with that of the control unit 160 of the mobile phone 100.

The sub-band decoder converts the M_data received through the second short range wireless communication module 230 into PCM data and transports the PCM data to the second audio processing unit 240.

The headset 200 can include a second display unit 250 for displaying user configuration information comprising the modification set of the M_data and information generated by a key input through the second key input unit 210, and current volume and remaining battery capacity.

A method of operation of the above-structured audio output system is described hereinafter in detail.

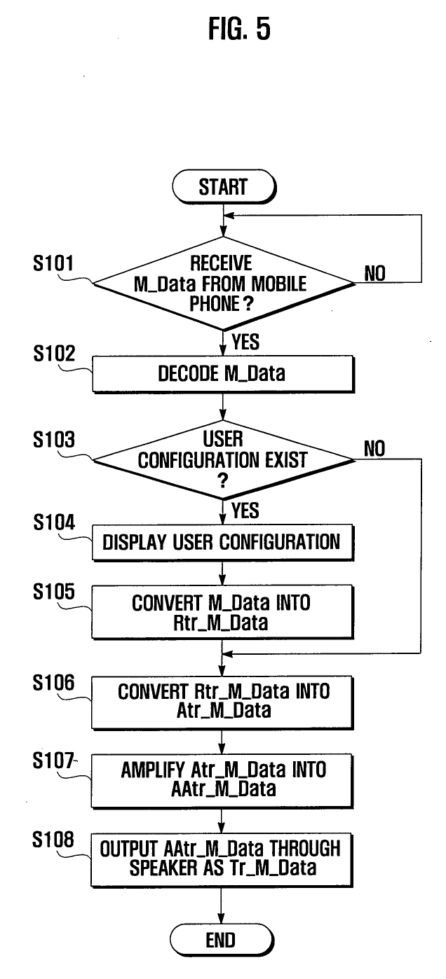

FIG. 5 is a flowchart illustrating an audio output system method according to the present invention.

In this method, it is assumed that the mobile phone 100 and the headset 200 are paired already such that a short range wireless communication channel has already been established between the mobile phone 100 and the headset 200.

Referring to FIG. 5, the headset control unit 260 of the headset 200 detects whether an M_data is received from the mobile phone 100 (step S101).

The headset 200 receives the M_data through a short range wireless communication channel established by the first short range wireless communication unit 130 of the mobile phone 100 and the second short range wireless communication unit 230 of the headset. The M_data includes music, voice, and nature sound data.

If an M_data is received from the mobile phone 100 (step S101), the headset control unit 260 decodes the M_data (step S102). The M_data is decoded using an audio codec, particularly using a sub-band codec (SBC) when the short range wireless communication units 130 and 230 of the mobile phone 100 and the headset 200 are Bluetooth modules.

Next, the headset control unit 260 checks whether a user configuration is set up for a specific sound effect (step S103). In detail, the second audio processing unit 240 of the headset 200 determines whether a user configuration exists. The user configuration is set by using the second key input unit 210. The user configuration can selected from a group of preset sound effect configurations consisting of default, 3D effect, pop, classic, rock, jazz, and dance. The preset sound effect configuration can be changed while playing the M_data by key input through the second input unit 210.

Next, the headset control unit 260 controls the second display unit 250 to display the information on the user configuration as a user configuration screen (step S104). The user configuration information display process is included only when the second display unit 250 is included in the headset 200.

If a user configuration is set up, the headset control unit 260 applies the sound effects corresponding to the user configuration to the M_data and outputs as a Raw_Transduced_M_data (step S105). The sound effect of the user configuration is applied to the M_data by the modifier 242. That is, the modifier 242 refers to the user configuration and selects a sound effect corresponding to the user configuration, e.g., among the 3D, pop, classic, rock, jazz, and dance effects, and then applies the selected sound effect to the M_data.

In more detail, the modifier 242 boosts or attenuates specific frequency bands of the M_data for applying the sound effect to the M_data. For example, the modifier 242 can delay the M_data before applying the 3D effect to the M_data. The modifier 242 can be implemented to change the respective equalization bands including the bass and soprano frequency bands. The modifier 242 can be controlled in accordance with a control input through the second key input unit 210 so as to output the RTr_M_data.

Next, the headset control unit 260 controls conversion of the RTr_M_data into an analog signal (ATr_M_data) (step S106). The RTr_M_data is converted into the ATr_M_data by the D/A converter 244.

Next, the headset control unit 260 controls amplification of the ATr_M_data so as to output an amplified analog signal (AATr_M_data) (step S107). The ATR_M_data is amplified by the amplification unit 246 so as to be output as the AATr_M_data.

Next, the headset control unit 260 outputs the AATr_M_data through the speaker (SPK) as an audible sound wave (Tr_M_data) (step S108).

If a user configuration is not set up at step S103, the M_data is regarded as RTr_M_data such that the headset control unit 260 controls the D/A converter 244 to convert the M_data into the ATr_M_data (step S106).

Although embodiments of the present invention are described in detail hereinabove, it should be clearly understood that many variations and/or modifications of the basic inventive concepts herein taught which may occur to those skilled in the present art will still fall within the spirit and scope of the present invention, as defined in the appended claims.

As described above, the audio output system and method for a mobile phone according to the present invention enable a sound effect to be applied at a headset, whereby a user can configure sound effects to be applied to an output sound with a headset without touching the mobile phone, resulting in improvement of user convenience.

What is claimed is:

1. An audio output method for a portable device outputting a sound through a sound output device, comprising the steps of:
establishing a communication channel between the portable device and the sound output device;
over the established communication channel, transmitting an audio stream from the portable device to the sound output device; and
at the sound output device, performing the steps of:
applying a sound effect to the audio stream, and
outputting the sound effect-applied audio stream.

2. The audio output method of claim 1, wherein the sound effect includes at least one of the effects selected from the group consisting of a stereo effect, a three-dimensional effect, a pop effect, a classic effect, a rock effect, a jazz effect, and a dance effect.

3. The audio output method of claim 1, wherein the sound effect is configured to adjust frequency bands of the audio stream.

4. The audio output method of claim 1, further comprising the steps of:
converting the audio stream into an analog signal;
amplifying the analog signal; and
outputting the amplified analog signal through a speaker of the sound output device.

5. The audio output method of claim 1, wherein the audio stream is coded and decoded using an audio codec and sub-band codec.

6. The audio output method of claim 1, further comprising the step of displaying information about the sound effect applied to the audio stream.

7. An audio output system comprising:
an audio playback device for producing an audio stream; and
a sound output device connected to the audio playback device to receive the audio stream and output the audio stream as an audible sound, the audio playback device applying a sound effect to the received audio stream prior to output thereof.

8. The audio output system of claim 7, wherein the audio playback device further comprises:
a first short range wireless communication unit for transmission of the audio stream through a wireless channel;
a first key input unit for generation of a command signal for transmission of the audio stream; and
a control unit for control of decoding of the audio stream and transmission of the decoded audio stream.

9. The audio output system of claim 8, wherein first short range wireless communication unit 130 includes Bluetooth, Zigbee, UWB, and IrDA technology.

10. The audio output system of claim 9, wherein the audio playback device further comprises:
a radio frequency unit for receipt of audio data from outside;
a memory unit for storing the audio data received from outside;
a first display unit for display of information about the audio data received from outside; and
an audio processing unit for generation of the audio stream from the stored audio data received from outside.

11. The audio output system of claim 8, wherein the audio playback device further comprises:
a radio frequency unit for receipt of audio data from outside;
a memory unit for storing the audio data received from outside;
a first display unit for display of information about the audio data received from outside; and
an audio processing unit for generation of the audio stream from the stored audio data received from outside.

12. The audio output system of claim 7, wherein the sound output device further comprises:
a second short range wireless communication unit for establishment of a communication channel with the first short range wireless communication unit of the audio playback device;
a second audio processing unit for application of a sound effect to the audio stream received from the audio playback device through the communication channel;
a second key input unit for configuration of the sound effect; and
a second control unit for control of a reception of the audio stream and output of the audio stream as an audible sound.

13. The audio output system of claim 12, wherein the first and second short range wireless communication units are each implemented with an identical Bluetooth module.

14. The audio output system of claim 12, wherein the sound output device further comprises a second display unit for display of information about the sound effect applied to the audio stream.

15. The audio output system of claim 14, wherein the first and second short range wireless communication units are each implemented with an identical Bluetooth module.

16. The audio output system of claim 7, wherein the sound effect further includes at least one preset sound effect configuration selected from the group consisting of a stereo effect, a three-dimensional effect, a pop effect, a classic effect, a rock effect, a jazz effect, and a dance effect.

17. The audio output system of claim 12, wherein the sound effect further includes at least one preset sound effect configuration selected from the group consisting of a stereo effect, a three-dimensional effect, a pop effect, a classic effect, a rock effect, a jazz effect, and a dance effect.

18. The audio system of claim 17, wherein a preset sound effect configuration can be changed while playing the M_data by key input through the second input unit.

19. The audio system of claim 12 wherein a preset sound effect configuration can be changed while playing the M_data by key input through the second input unit.
